(19) United States
(12) Patent Application Publication
(10) Pub. No.: US 2021/0362246 A1
(43) Pub. Date: Nov. 25, 2021

(54) Drill Guides With Canting Base and Dowel Jig Attachments

(71) Applicant: Charles Hadley Cammack, Lenexa, KS (US)

(72) Inventor: Charles Hadley Cammack, Lenexa, KS (US)

(21) Appl. No.: 17/392,142

(22) Filed: Aug. 2, 2021

Related U.S. Application Data
(63) Continuation-in-part of application No. 16/778,616, filed on Jan. 31, 2020.

(51) Int. Cl. B23B 47/28

(52) U.S. Cl. CPC B23B 47/287

(57) ABSTRACT

These inventions include three drill guides (Multiguide, Triguide, and Uniguide), and two attachments (canting base and dowel jig). The drill guides allow users to drill holes to prescribed depths into flat work surfaces using various sizes of bits including twist and auger bits while eliminating marring and reducing wood splintering. The canting base attachment allows users to drill holes to prescribed depths and at variable angles into flat surfaces and both large and small cylinders having zero, one, or two free ends using various kinds and sizes of drilling tools including twist, auger, and Forstner bits. The dowel jig attachment allows users to drill dowel holes to prescribed depths in edges and faces of workpieces that are evenly spaced apart by numerous gauged distances and at adjustable distances from edges without slippage or misalignment. These inventions have drill press-like capabilities and can be used in fields and shops.

### RELATED APPLICATION

This application claims the priority benefit of U.S. Provisional Patent Application Ser. No. 62/814,170 filed 5 Mar. 2019 which is incorporated by reference herein.

This application also claims the priority benefit of U.S. Nonprovisional patent application Ser. No. 16/778,616 filed on 31 Jan. 2020 which is incorporated by reference herein.

### RELATED US PATENT DATA

All related US Patent Data known to the inventor are listed in the parent application and are incorporated by reference herein.

### FIELD OF THE INVENTION

Charles Hadley Cammack, a US citizen and resident of Lenexa, Kans. located in Johnson County has invented three new drill guide and depth-stop tools named Multiguide, Triguide, and Uniguide (hereinafter drill guides) that stem from the original drill guide invention disclosed in the parent application. These new drill guides, without attachments, allow users to drill holes to precise depths perpendicular to flat working surfaces.

Charles Cammack has also invented a new canting base attachment to those three new drill guides that allows users to drill inclined holes to precise depths into flat working surfaces and through the center of cylinders on which the canting base is placed. The canting base is bolted to drill guides. Thus, users can hold a new drill guide and new canting base with one hand as a unit while operating a drill with their other hand. Convenience, stability, and safety are increased compared to the original drill guide and original canting base disclosed in the parent application.

Cammack has also invented a new dowel jig attachment that allows users to accurately align drill holes separated laterally by gauged distances through both edges and faces of workpieces. The new dowel jig does not have sliding adapters that connect drill guides to a dowel jig which are needed with the original dowel jig. This change eliminates the potential for inadvertent slippage and misplacement of dowel holes. These inventions generally relate to woodworking and joinery, although the inventions can also be used with other crafts and materials.

The parent application includes a brief discussion of other embodiments that would serve as bushing carriers but does not include any drawings or claims related to those embodiments. Triguide and Uniguide disclosed in this continuation-in-part application serve as bushing carriers.

Drill presses allow users to drill holes to precise depths and alignments in small workpieces. These three new drill guides allow users to drill holes to precise depths and alignments in workpieces that are too large for drill presses and can thus be used in fields and shops.

Like the original drill guide disclosed in the parent application, Multiguide, Triguide, and Uniguide (drill guides) allow users to:
drill holes to prescribed depths perpendicular to flat working surfaces with no marring and reduced wood tear out using hand-held electric drills
drill holes to precise depths and at variable angles into flat work surfaces and both large and small cylinders using various kinds and sizes of drilling tools including twist, spade, auger, Forstner, and brad-point bits as well as countersinks, unibits, and taps
place these tools on cylinders whereas prior art requires users to place cylinders within tools
drill holes at various angles of inclination through the center of both large and small diameter cylinders and cylinders having no free end
drill dowel holes on edges and faces of workpieces that are spaced apart by various gauged distances and aligned at precise distances from workpiece edges

### DISCUSSION OF PRIOR ART

Prior art is described in the parent application and is incorporated by reference herein.

### BRIEF SUMMARY OF THE INVENTION

### Multiguide

Multiguide is most useful when drilling just a few holes to one precise depth that are aligned perpendicular to a working surface. Multiguide is best used in spur-of-the-moment situations because it is quick to set up for depth and includes many bushing sizes.

Multiguide allows users to drill holes aligned perpendicular to flat working surfaces to one prescribed maximum hole depth per bit size and length. Rotating drill chucks meet Multiguide, not working surfaces, when maximum hole depth is reached avoiding any marring. Multiguide bears on working surfaces around bits reducing wood tear out.

No tools are required for depth adjustment and setup times are short. Additionally, Multiguide allows users to drill through holes of multiple sizes that are aligned perpendicular to flat working surfaces with just one setup.

Users can drill holes to prescribed depths that are perpendicular to flat working surfaces using Multiguide and drilling tools such as Forstner bits by holding their shanks against notches in the Multiguide. It is necessary to raise the base of Multiguide to provide space for the bit. This can be done by placing a simple block or the canting base attachment beneath Multiguide.

Multiguide supports both functions (maximum hole depth and perpendicular alignment with working surfaces) without requiring that it be connected to an electric drill. Multiguide excels when just a few holes of just one size must be drilled to some maximum depth, and when multiple through holes of different sizes must be drilled.

### Triguide

Triguide is similar in form to Multiguide and identical to Multiguide in function but has three replaceable bushing carriers rather than multiple fixed bushings. Triguide thus has a longer service life than Multiguide.

Users can drill through holes having as many as three different sizes. For example, a user might have two drills, each holding a different bit diameter. With corresponding bushing inserts installed, users can drill pilot holes with one drill and bushing, then drill full-sized holes using a second bit and bushing. Holes will be aligned perpendicular to flat working surfaces. Other embodiments having more or fewer bushings in each plate can readily be developed. Additionally, inserts and bushings can be replaced by full-sized bushings having threaded edges.

### Uniguide

Uniguide differs greatly in appearance and form from the original drill guide, Multiguide, and Triguide in that it has, in its most simple form, just one somewhat cylindrical body that contains a top and a bottom bushing insert that limit depth of drilling and align drill bits perpendicular to flat working surfaces. Long drill bits can be used with Uniguide by attaching one or more segments to its top and installing a bushing insert in the top-most segment rather than the body. Bushings work best with twist bits. Uniguide can also be used with drilling tools having bits that are larger than their shanks such as Forstner bits. Uniguide provides infinitely fine depth control for many drilling tool types. Uniguide can be used in tighter quarters than the original drill guide, Multiguide, and Triguide because it has a smaller footprint.

### Centering and Alignment System

Multiguide, Triguide, Uniguide, canting base attachment, and dowel jig attachment employ the same centering and alignment system. A shallow threaded hole is formed at the center of the bottom of all three new drill guides that can receive the threaded end of either a connecting bolt (used with a canting base) or a centering pin (used with the dowel jig). Connecting bolts secure drill guides to canting base attachments. Centering pins engage matching recesses in dowel jig attachments.

Shallow threaded alignment pin holes are formed at constant radial distances from the center hole in drill guide bottom faces that can receive threaded alignment pins when used with attachments. The number and locations of threaded alignment pin holes varies among the three new drilling guides, but the pins are interchangeable.

### Canting Base Attachment

The canting base attachment to drill guides allows users to drill inclined holes into flat working surfaces. The canting base attachment aligns with cylinder centers when placed upon cylinders having zero or more free ends. Holes can then be drilled through cylinder centers that extend to precise depths. The new canting base is secured to a drill guide using a connecting bolt. Users thus manipulate both with just one hand while operating a drill with their other hand. This increases stability, convenience, and safety compared to the original canting base attachment.

### Dowel Jig Attachment

The new dowel jig attachment disclosed in this continuation-in-part application differs from the original attachment in that it has no sliding pin adapters. Rather, replaceable pins are added to the drill guides and pin recesses are formed in the tops of sliding blocks. This simple change eliminates sliding pin adapters and the possibility of inadvertent movements and misplacement of dowel holes. The new dowel jig brace provides more convenient and secure surfaces for exterior clamping devices.

Self-centering dowel jigs can only be used correctly on uniformly thick edges of workpieces having zero or two veneered or finished faces. If workpieces have only one finished or veneered face, then holes should be located at their structural centers, not their geometric centers. It is often desirable to locate dowel holes closer to one face than another to increase joint strength.

Good joinery requires that face-to-dowel hole distances be constant and does not require that dowel holes be placed at geometric centers of workpieces. Consider a shelf supported by dowels. For reason of increased strength, dowel holes will desirably be located below the shelf's geometric center. This new dowel jig does not force users to place dowels at the geometric center of an edge. Dowel holes can be accurately located at any location including geometric and structural centers. The new drill guides and new dowel jig attachment enable users to drill multiple dowel holes to prescribed depths in the edges and faces of workpieces that are evenly spaced apart and accurately aligned at one setup location.

Self-centering dowel jigs cannot be used on broad faces of workpieces. Both the new and original dowel jigs can be used to drill dowel holes into broad faces of workpieces.

Dowel jigs must be properly positioned on an edge or face of a workpiece at a first location. This new dowel jig attachment can be automatically and correctly positioned at a second location on an edge or face by simply placing it against the workpiece using the last drilled hole and the workpiece edge as guides. The new dowel jig is thus described as being self-aligning rather than self-centering.

The new dowel jig brace disclosed in this continuation-in-part application has only one gusset plate and provides three suitable locations for external clamps. The new dowel jig brace can readily be used to drill holes into the narrow ends of long workpieces and is much more convenient and secure than the original dowel jig brace.

With the dowel jig brace removed, the new dowel jig attachment can be placed at any location on faces of workpieces and clamped in place. Flanges can be added to the dowel jig body to increase the convenience and effectiveness of exterior clamps. Dowel holes for shelving can be installed that do not fully penetrate the workpiece because holes will be drilled to prescribed depths.

### OBJECTS AND SUMMARY OF THE INVENTION

The object of the Multiguide, Triguide, Uniguide, new canting base, and new dowel jig inventions disclosed in this continuation-in-part application is to improve upon the convenience, stability, and safety provided by the inventions disclosed in the parent application. These improvements come about largely by reversing the positions of pins and matching recesses among the new drill guides and attachments. Though seemingly a trivial change, it leads to great improvements in convenience, stability, and safety when the new drill guides are used in conjunction with the new canting base and dowel jig attachments. In particular, the new canting base can be securely attached to the drill guides and sliding block adapters are not needed with the new dowel jig.

The parent application includes a thorough discussion of the objects and summary of the original drill guide and its attachments. The objects and summary of the inventions disclosed in this continuation-in-part application are very similar to the objects and summary of the present inventions.

Many existing depth-stop tools can limit hole depth but cannot align drilling tools perpendicular to working surfaces or at various prescribed angles relative to working surfaces. Some tools align bits perpendicular to working surfaces but cannot limit hole depth unless used in combination with other tools. Many existing depth-stop tools rotate when they contact working surfaces marring them. Most depth-stop tools do not reduce wood tear out. Most depth-stop tools only support the use of drilling tools that have bits and shanks of the same diameter. One drilling tool maintains drilling tools perpendicular to flat working surfaces and limits hole depth, but only supports tools that have bits larger in diameter than their shanks (one shank size). Additionally, it is necessary to remove the drilling tool from the depth-stop and alignment tool to change bits. This device also requires long drilling tools.

It is therefore an object of the present invention to allow users to drill holes to prescribed depths that are aligned normal to work surfaces without marring and with reduced wood tear out using drilling tools having bits that are the same size or larger than their shanks.

Some depth-stop tools can be used to drill through the center of small cylindrical objects placed in them but cannot be used on large diameter pipes or on installed pipes having no free ends. It is an object of this invention to allow users to drill holes to prescribed depths through the center of large and small cylindrical objects in both shops and fields, and at variable inclinations, even if they have no free ends. A further object of these inventions is to provide a tool assembly that can be controlled with just one hand.

No existing depth-stop tools that attach to twist bits can be used with drilling tools having bits larger in diameter than their shanks. Many existing depth-stop tools are formed as a collar that is secured to bits using a set screw that can be easily lost and which requires a tool for operation. Set screws must bear on the lands of bits to work properly and to avoid damaging drill tools. Another kind of collar fits several sizes of bits, but has an appreciable length reducing the maximum depth of drilling for a given bit length and increasing the required length of drilling tools. Other depth-stop tools are disposable, lack precision, or deform during use changing depth control.

It is an object of this invention to allow users to align drilled holes perpendicular to work surfaces and to control the depth of drilling when using drilling tools having bits that are larger than their shanks and to eliminate the need for supplemental tools and fasteners.

Self-centering dowel jigs cannot be used to drill dowel holes in the faces of flat workpieces. In addition, self-centering is not desired when workpieces have only one finished or veneered face, or when drilling dowel holes for miter joints. It is therefore an object of this invention to permit users to drill evenly spaced-apart holes to specific depths into edges of workpieces that are located at constant distances from workpiece edges.

It is a further object of this invention to allow users to drill evenly spaced-apart dowel holes in the faces of workpieces.

It is an object of this invention to allow users to drill dowel holes for multiple bit diameters and variable spacings including standard spacings.

It is an object of this invention to allow the creation of both blind and through miter joints.

It is an object of this invention to allow users to secure Multiguide, Triguide, or Uniguide to the canting base attachment so that they become a unit that users can control with one hand while operating a drill with their other hand.

It is a further object of this invention to eliminate the need for users to swap out pin adapters for blank adapters while drilling dowel holes.

It is a further object of this invention to provide a dowel jig brace that allows users to more conveniently and safely clamp the dowel jig to narrow workpieces.

### BRIEF DESCRIPTION OF THE FIGURES

Figures showing the preferred embodiment of the invention are briefly described as follows:

FIG. 1 depicts a vertically exploded Multiguide viewed from above.

FIG. 2 depicts the assembled Multiguide viewed from above.

FIG. 3 depicts the assembled Multiguide viewed from below.

FIG. 4 depicts the vertically exploded Triguide viewed from below

FIG. 5 depicts the assembled Triguide viewed from above.

FIG. 6 depicts the assembled Triguide viewed from below.

FIG. 7 depicts the vertically exploded Uniguide viewed from above.

FIG. 8 depicts the assembled Uniguide viewed from above.

FIG. 9 depicts the assembled Uniguide with one segment attached as viewed from below.

FIG. 10 depicts the assembled Uniguide viewed from above without reference numbers

FIG. 11 depicts the assembled Uniguide with the jacking device installed

FIG. 12 depicts a top-rear view of the new canting base attachment.

FIG. 13 depicts a bottom-front view of the new canting base attachment.

FIG. 14 depicts the assembled dowel jig attachment viewed from above.

FIG. 15 depicts the assembled dowel jig attachment viewed from below.

FIG. 16 depicts a top-front view of the center sliding block.

FIG. 17 depicts a bottom-rear view of the center sliding block.

FIG. 18 depicts a top-front view of an outboard sliding block.

FIG. 19 depicts a bottom-front view of an outboard sliding block.

FIG. 20 depicts a top-front view of the dowel jig brace.

FIG. 21 depicts a bottom-rear view of the dowel jig brace.

### DETAILED DESCRIPTION OF PREFERRED EMBODIMENT

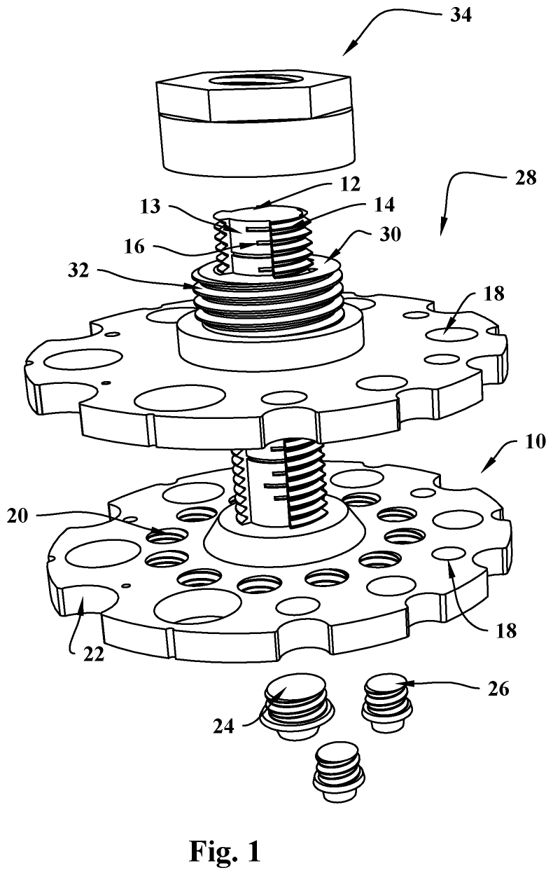

FIG. 1 shows the four primary Multiguide components (top plate 28, bottom plate 10 with integral threaded shaft 12 and double nut 34) in an exploded view. Shaft threads 14 are interrupted by longitudinal alignment grooves 13. Depth graduations 16 are formed in alignment grooves. Multiple fully circular bushing holes 18, and multiple semi-circular edge notches 22 are formed in both the top and bottom plates. Bushings and notches in the two plates are aligned.

A collar 30 integrally formed with the top plate has external threads 32 that engage the double nut 34 shown above the shaft. The double nut has an upper set of internal threads that engage the shaft threads 14 and a lower set of internal threads that engage the collar connecting threads 32.

A centering pin 24 shown directly below the center of the bottom plate can be installed in a threaded hole in the bottom surface of the bottom plate. A pair of alignment pins 26 are shown spaced apart from the center pin by a constant radial distance and spaced apart from each other by an angular distance. Threaded ends of alignment pins can be installed in threaded alignment pin holes 20 in bottom plates that surround the shaft 12.

Two alignment pins are installed in Multiguide if it is used with an attachment. A centering pin 24 is installed in a threaded hole in the center of the bottom face of the Multiguide if it is to be used with the dowel jig. The centering pin is replaced with a connecting bolt (not shown in this view) if Multiguide is attached to a canting base.

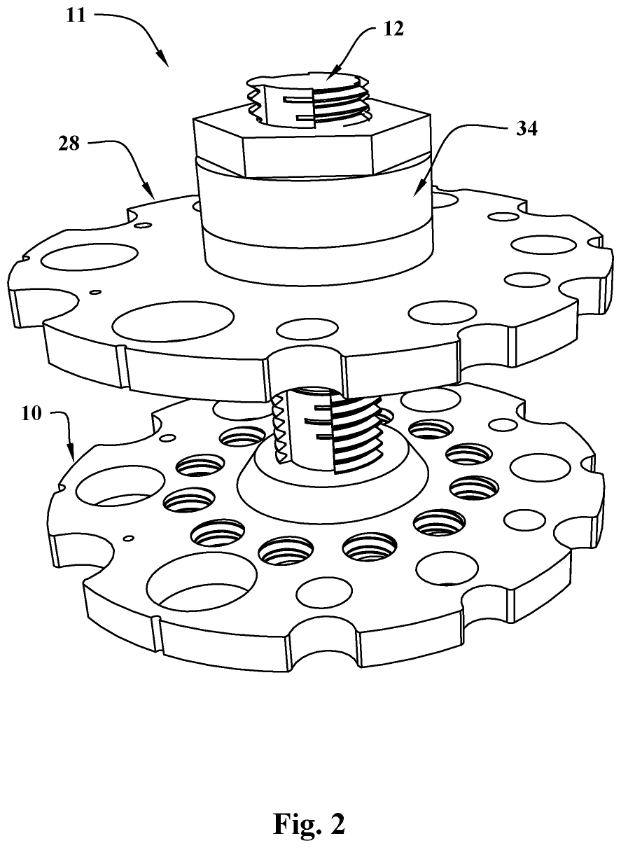

FIG. 2 shows a top-isometric view of the assembled Multiguide 11. The bottom plate 10, top plate 28, and double nut 34 move as a unit when the double nut is secured to the shaft 12 and top plate.

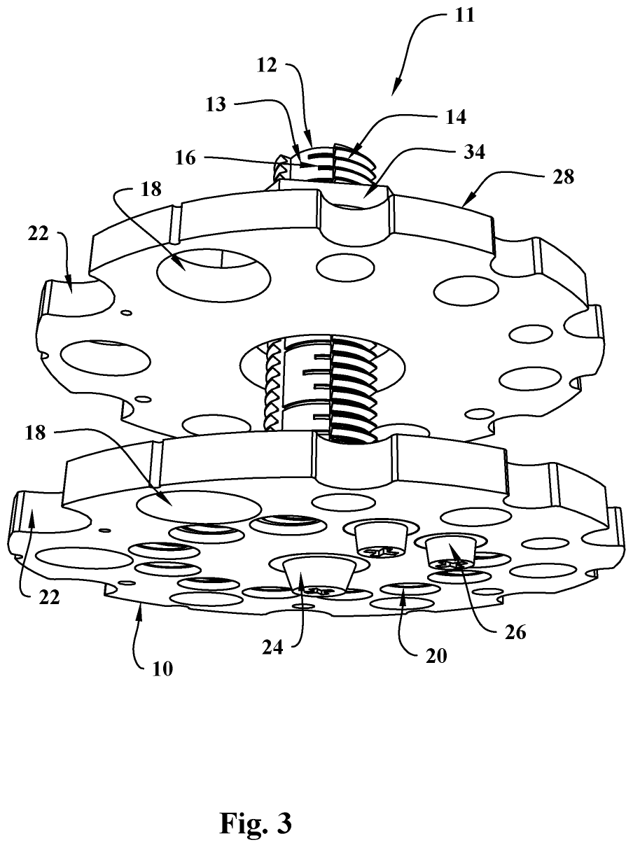

FIG. 3 shows a bottom-isometric view of the assembled Multiguide 11 that includes a bottom plate 10 with integral shaft 12, top plate 28 with integral collar 30, and a double nut 34. Bushings 18 and semi-circular edge notches 22 are formed in top and bottom plates. The top plate 28 is slidingly connected to the shaft 12 and secured in position by the double nut 34. Shaft threads 14 are seen interrupted by longitudinal alignment grooves 13 that maintain alignment of bushings in top and bottom plates. Depth graduations 16 are formed in a shaft groove 13. The centering pin 24 is seen installed in the center of the bottom plate 10. A multiplicity of alignment pin holes 20 are formed in the bottom of the bottom plate. Two alignment pins 26 are installed in two threaded alignment pin holes 20 in the bottom surface of the bottom plate 10.

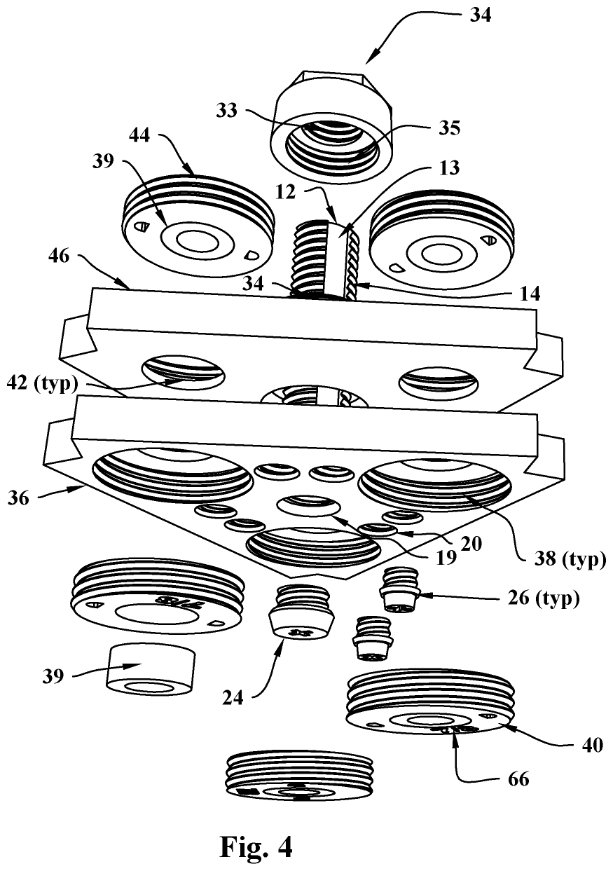

FIG. 4 shows a vertically exploded isometric view of Triguide which has a bottom plate 36, top plate 46, double nut 34, three upper bushing inserts 44, and three lower bushing inserts 40. The top Triguide plate is slidingly connected to the shaft 12 that is rigidly attached to the bottom plate and has external threads 14 interrupted by longitudinal alignment grooves 13.

The upper portion of a double nut 34 has internal threads 33 that engage shaft threads, and the lower portion has larger internal threads 35 that engage collar threads. The double nut secures the top plate 46 to the shaft 12 when the double nut is threaded onto the collar of the top plate (not visible in this view).

Three counterclockwise (CCW) threaded lower bushing insert holes 38 are formed in the bottom surface of the bottom plate. Each such threaded hole receives a threaded lower bushing insert 40. Likewise, three CCW threaded upper bushing insert holes 42 are formed in the top surface of the top plate 46 that receive a threaded upper bushing insert 44. Triangular edge notches 45 are formed at each apex of both the top and bottom Triguide plates that serve as partial bushings for drilling tools having bits that are larger than their shanks.

A threaded centering pin hole 19 is formed at the center of the bottom surface of the bottom plate. Three pairs of threaded alignment pin holes 20 are formed in the bottom surface of Triguide's bottom plate at a constant radial distance from the shaft. Each pair of alignment pin holes in this embodiment is paired with the threaded lower bushing insert hole 38 located on the opposite side of the shaft. Each bushing insert (40 and 44) has a bushing 39 and a size label 66. Two alignment pins 26 and a center pin 24 can be seen in alignment with corresponding holes.

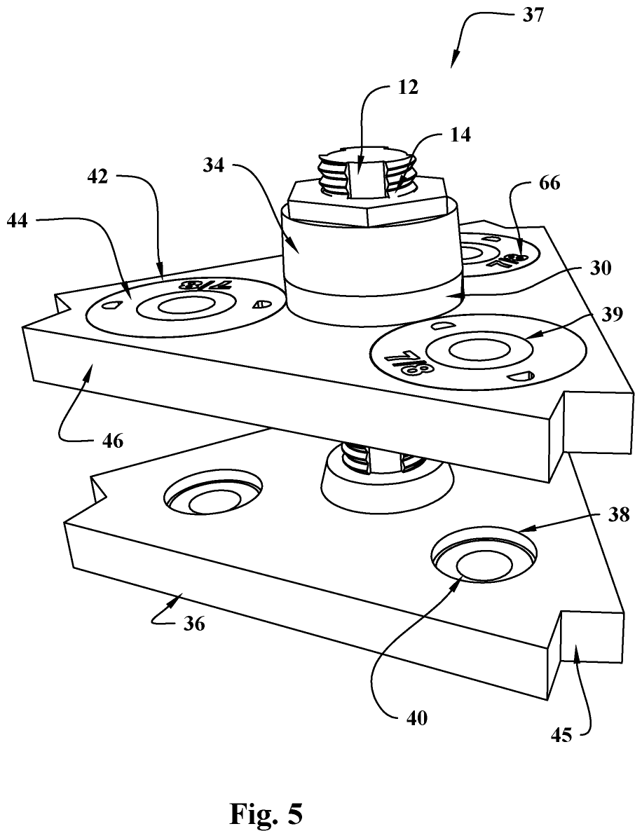

FIG. 5 shows a top view of the assembled Triguide 37. The shaft 12, top plate 46, bottom plate 36, upper bushing inserts 44, and bushings 39 are visible in this view. CCW threads are in all cases. Bushing size is indicated by a bushing size label 66. A lower bushing insert 40 is installed in each of three lower bushing insert holes 38. A threaded upper bushing insert 40 is installed in each of three upper bushings holes 42 in the top plate. A bushing is installed in each bushing insert. A triangular edge notch 45 is formed at each apex of the two plates. The double nut 34 secures the top plate to the collar 30 and shaft 12. An alignment groove 13 and shaft threads 14 are also visible. Plate separation and length of drill bit extending beyond the drill chuck determine hole depth.

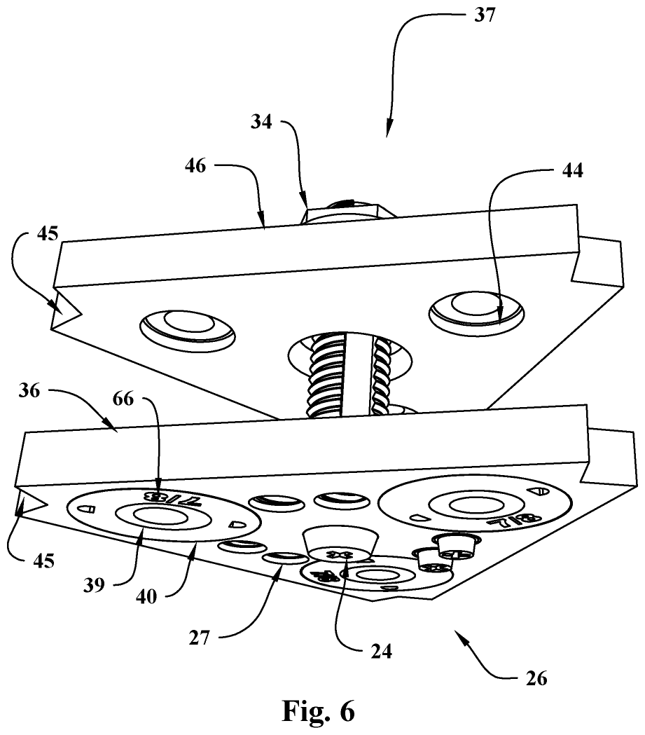

FIG. 6 shows the assembled Triguide 37 as viewed from below. A double nut 34 secures the top plate 46 to the shaft 12. Three lower bushing inserts 40 with bushings 39, a pair of alignment pins 26, and one centering pin 24 can be seen installed in the corresponding threaded holes. Threaded lower bushing inserts are installed from below. Their faces are even with the bottom plate surface when fully installed. Threaded upper bushing inserts 42 with bushings 39 are installed in the top surface of the top plate. Edge notches 45 serve as partial bushings for drilling tools having bits that are larger than their shanks. Three different bushing sizes can be installed at one time.

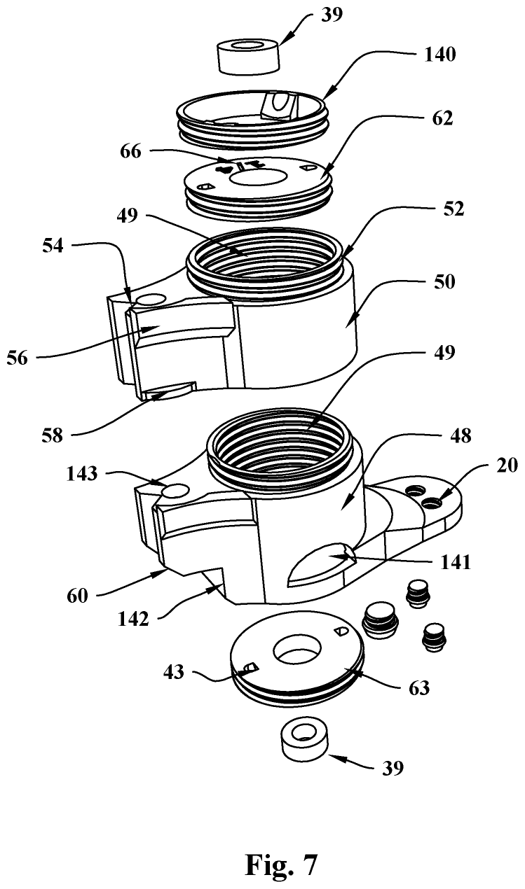

FIG. 7 shows an exploded view of a Uniguide assembly that is composed of a Uniguide body 48, one optional segment 50, an upper threaded bushing insert 44, an insert locking ring 140, and one lower threaded bushing insert 40. Bushings 39 are installed in each bushing insert. The Uniguide body can be used with no segments or with many segments. This view shows that the Uniguide body has external connecting CCW threads 52, a threaded upper bushing insert hole 42, two threaded alignment pin holes 20, a Uniguide edge notch 54, a stop block 56, and a beveled face 60 that is interrupted by a Forstner bit recess 142.

Each segment 50 has a threaded upper bushing insert hole 42, an edge notch 54, a stop block 56, and a stop block projection 58.

A threaded upper bushing insert 44 can be installed in either the top-most segment or, if no segments are installed, the Uniguide body. A threaded lower bushing insert 40 is installed in the threaded hole in the bottom of the Uniguide body when drilling tools have bits and shanks of the same diameter. Two bushing rotation tool holes 43 are formed in each bushing insert, and a bushing size label 66 is formed on one face of each bushing insert.

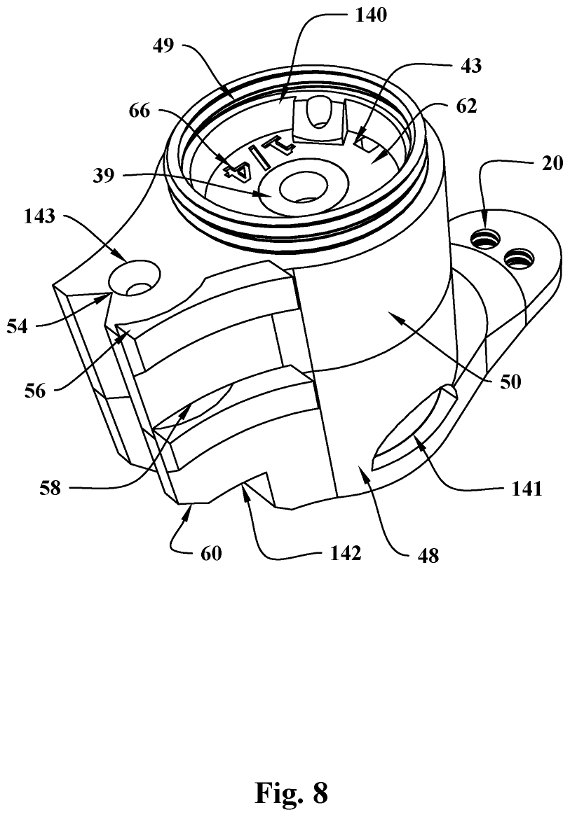

FIG. 8 shows a top isometric view of a Uniguide assembly. The upper bushing insert 44 is installed in the upper bushing insert hole 42 in the segment 50 or the Uniguide body 48 so that the desired hole depth is achieved when the drill chuck meets the bushing 39 in the upper bushing insert. The bushing size label 66 is marked on each bushing insert. In this embodiment, two bushing rotation tool holes 43 allow users to rotate the bushing insert using, for instance, a needle nose pliers. An insert locking ring 140 prevents upward movement of the upper bushing insert due to friction between drill bits and bushings. Hard drill chuck stops 143 prevent damage to segments and Uniguide bodies when rotating drill chucks contact them. Segments 50 are installed on Uniguide bodies by threading them in a CCW direction.

A stop block 56 and stop block projection 58 force proper alignment of edge notches 54. Two threaded alignment pin holes 20 are visible in the Uniguide body. A cuttings port 141 is formed in one side of the Uniguide body just above the top of the bottom bushing insert.

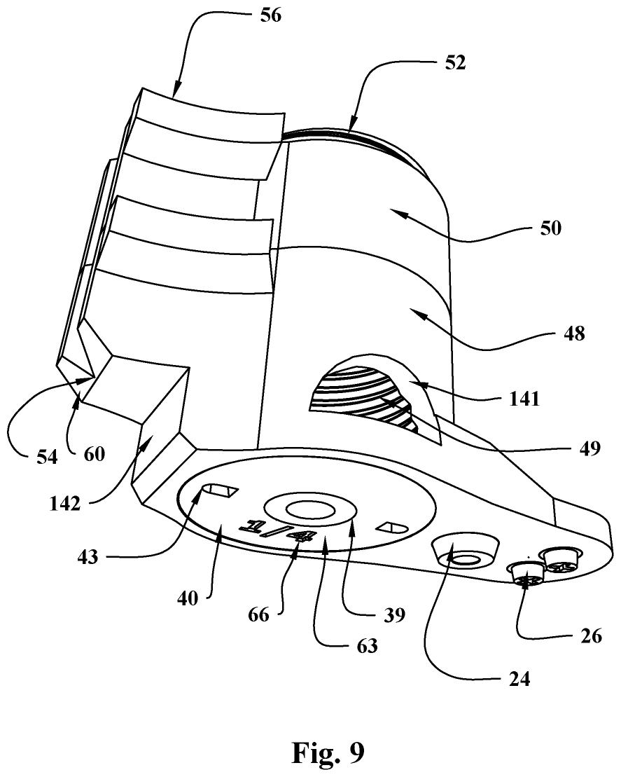

FIG. 9 shows a bottom isometric view of a Uniguide body 48 with one segment 50 optionally added forming an assembly. A threaded lower bushing insert 40 is shown installed in the bottom of the Uniguide body. When installed fully into the threaded hole, the bottom face of the lower bushing insert is flush with the bottom face of the Uniguide body.

A beveled face 60 allows the Uniguide body and canting base attachment to rotate without undue restriction. The centering pin 24 and two alignment pins 26 are installed in the corresponding threaded holes in the bottom face of the Uniguide body. When properly assembled, notches 54 in the Uniguide body and segments align. Multiple segments can be added via the external connector threads 52. The top bushing insert threaded hole 62 is visible through the cuttings port 141.

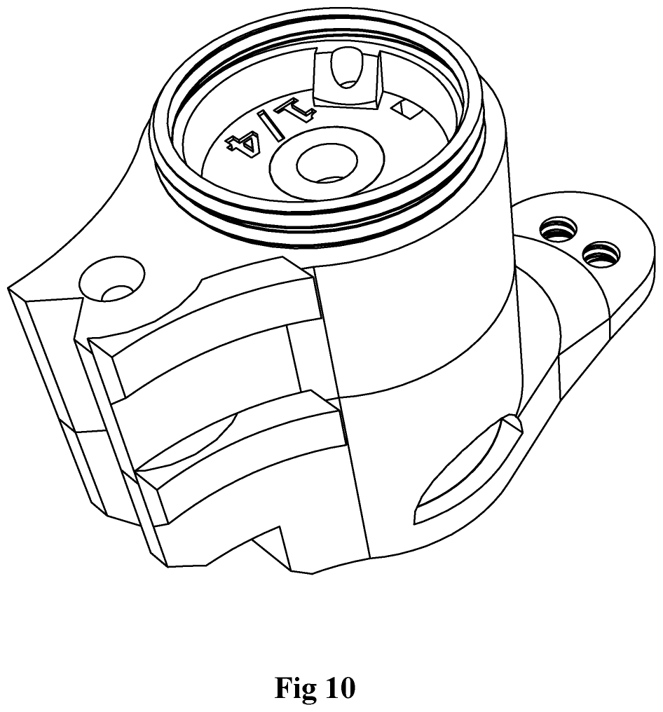

FIG. 10 shows an assembled Uniguide with one segment without reference numbers and viewed from above.

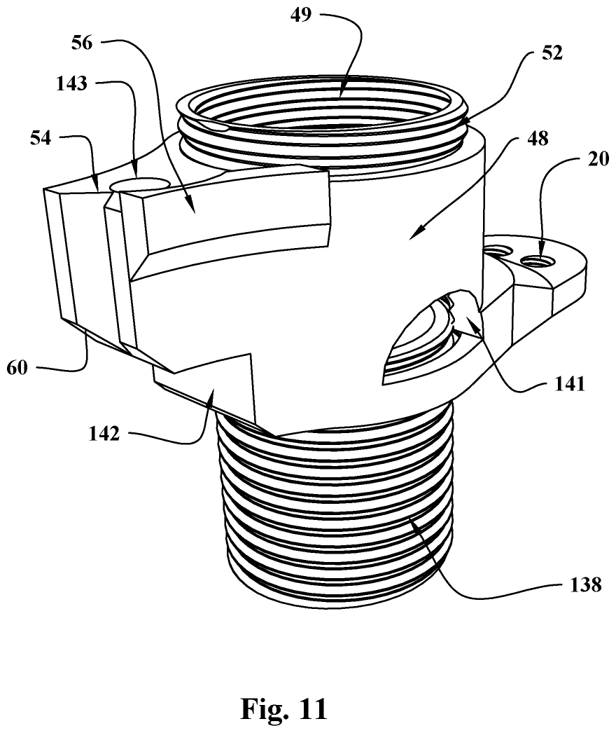

FIG. 11 shows a view of the Uniguide body 48 with a threaded jack 138 installed in place of the top and bottom bushing inserts. The jack moves the Uniguide body upward until the top of the edge notch 54 is positioned for the correct hole depth. Drill bits stop advancing when drill chucks meet the drill chuck stop 143.

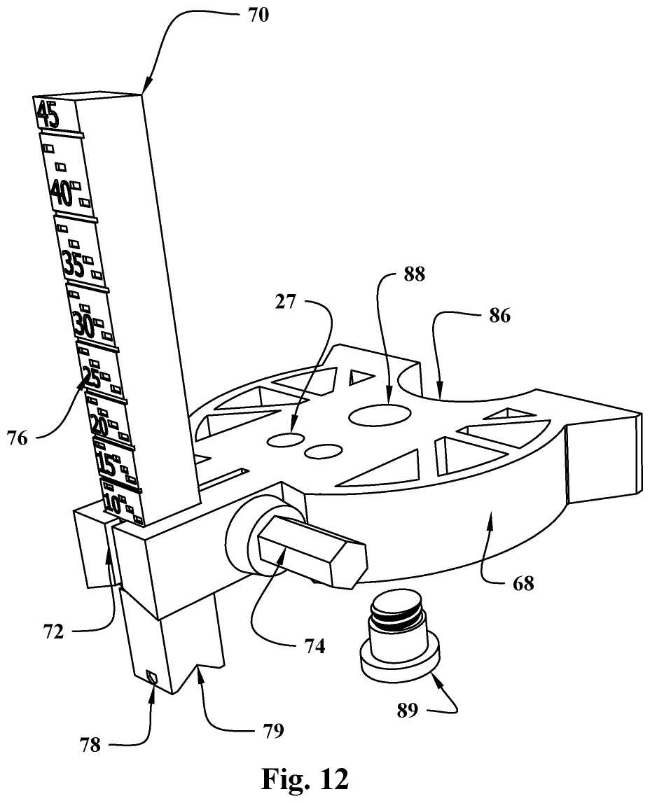

FIG. 12 shows a top-rear isometric view of the canting base attachment 68 with a canting shaft 70 secured in the canting base shaft slot 72 by the canting base clamp 74. Angle graduations 76 are marked on the canting shaft that can be used when drilling into flat working surfaces.

A canting base shaft center point 78 formed in the bottom end of the canting shaft can be used when drilling into flat surfaces to aid in aligning the canting base. The canting shaft will be installed in the canting base slot with angle graduations facing to the left or right rather than the rear when drilling into cylinders. The canting base cylinder shaft notch 79 aids in aligning the canting base on cylinders.

A canting base bolt hole 88 fully penetrates the canting base attachment at its center. A canting base bolt 89 is shown directly below the bolt hole. Two alignment pin recesses 27 are formed in the top surface of the canting base. A drill bit recess 86 is formed in the front face of the canting base attachment.

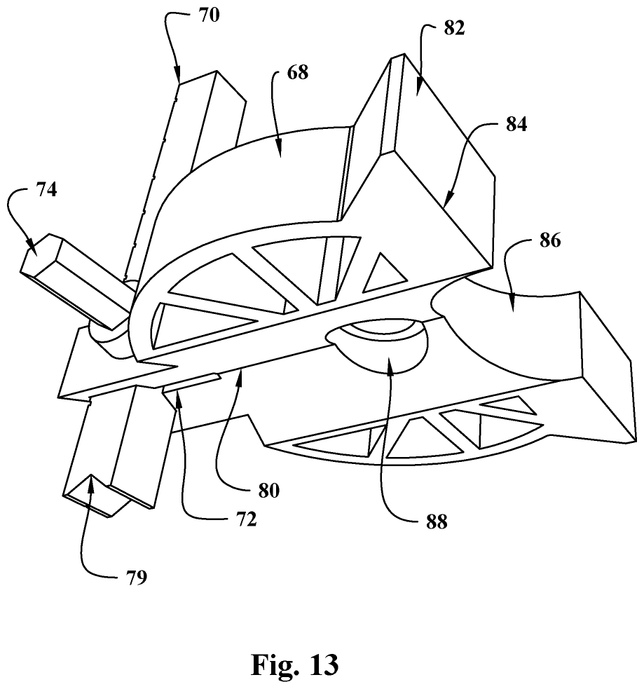

FIG. 13 shows a bottom-front isometric view of the canting base attachment 68. The canting base groove 80 and the canting base bolt hole 88 are visible in the bottom surface of the canting base. The canting base pivot edge 84 is visible at the bottom of the front face 82. The canting base shaft slot 72 is also visible at the apex of the groove. The shaft 70 can move up and down in the slot except when clamp 74 is tightened. The drill bit recess 86 is visible at the front end of the canting base. The canting base shaft cylinder notch 79 conforms the attachment to cylinders when the shaft is rotated 90° in the slot so that angle graduations face to the left or right side of the attachment.

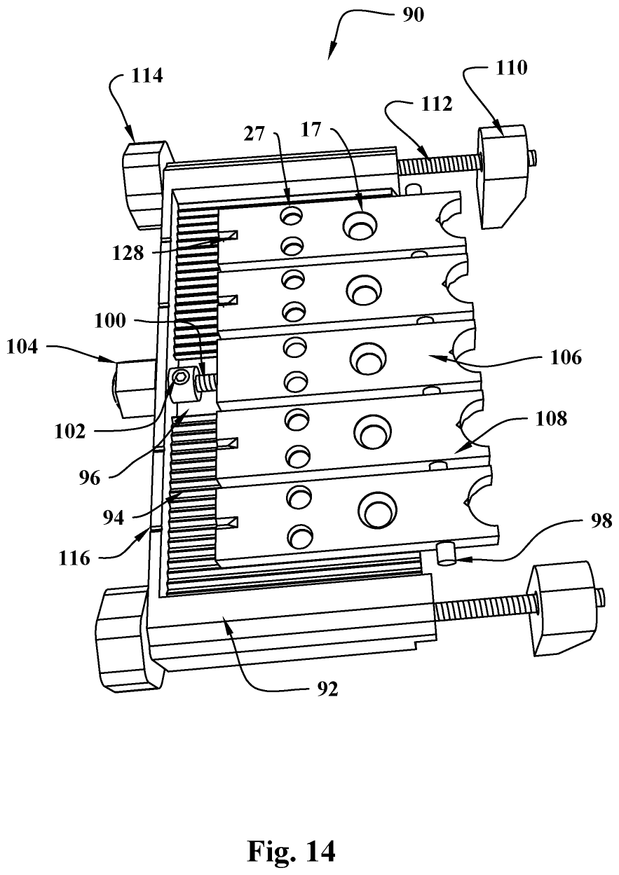

FIG. 14 shows a top isometric view of the dowel jig assembly 90 that includes the dowel jig body 92, center sliding block 106, and four outboard sliding blocks 108 as shown in this embodiment. The center sliding block slides forward and back within the center sliding block groove 96 formed in the top surface of the dowel jig body. The outboard sliding blocks move forward and backward on the dowel jig alignment grooves 94 that engage grooves in the bottom surface of the outboard sliding blocks. These alignment grooves prevent lateral movement of outboard sliding blocks and insure graduated spacings.

All sliding blocks are held in fore-and-aft position by a threaded position rod 100 and a sliding block locking rod 98 that passes laterally through each sliding block.

The threaded position rod 100 is operated by turning a sliding block position control knob 104 acting against the back wall of the dowel jig body and a locking collar with set screw 102. A pair of threaded dowel jig clamp rods 112, dowel jig clamps 110, and dowel jig clamp knobs 114 are used to secure the dowel jig body to workpieces.

A centering pin recess 17 and two alignment pin recesses 27 are formed in the top surface of each sliding block. A sliding block center mark 128 is formed in the center of the back edge of each outboard sliding block. Standard spacing alignment notches 116 are formed in the back wall of the dowel jig body that align with the sliding block center marks when using standard spacings.

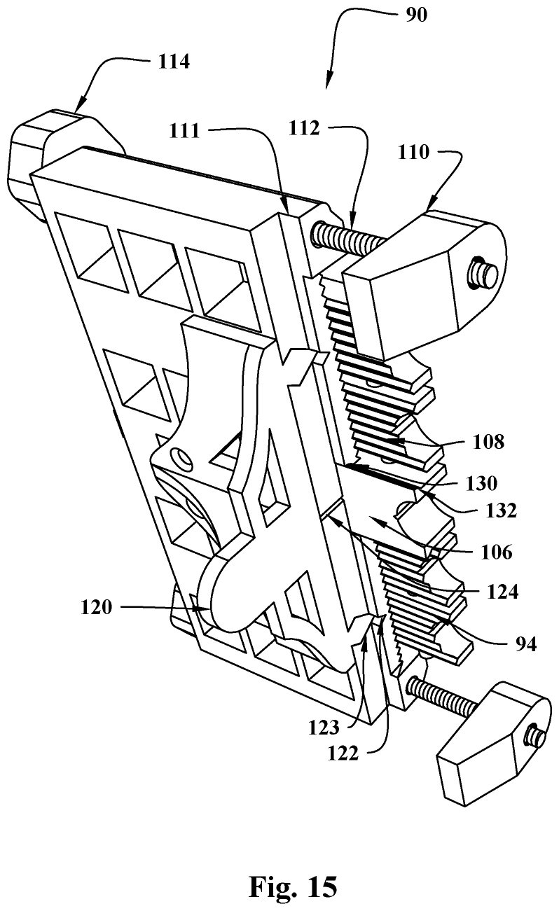

FIG. 15 shows a bottom isometric view of the dowel jig assembly 90 with the dowel jig brace 120 that is attached when drilling dowel holes into edges of workpieces. The dowel jig alignment edge 111 is visible near the front edge of the dowel jig body. The center sliding block 106 is seen to have a flat bottom surface while the outboard sliding blocks 108 have grooved bottom surfaces. A dowel jig center mark 124 is seen on the front face of the dowel jig body beneath the center sliding block. Dowel jig alignment grooves 94 are visible on the bottom surfaces of outboard sliding blocks.

Dowel jig engagement fittings 123 on the top surface of the dowel jig brace 120 slide into dowel jig brace engagement slots 122 formed in the bottom of the dowel jig body. A center sliding block flange groove 130 is formed on both sides of the dowel jig center groove 124. Center sliding block flanges 132 formed on the long bottom edges of the center sliding block engage the sliding block flange grooves and prevent upward and downward movement of center sliding blocks.

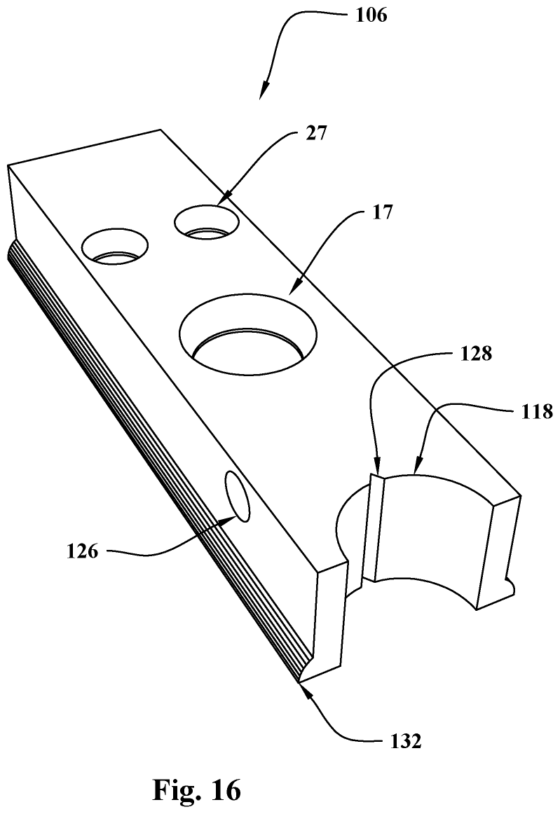

FIG. 16 shows a top-front view of a center sliding block 106. A center sliding block flange 132 is formed on each long bottom edge of the center sliding block. A sliding block locking rod hole 126 passes laterally through all sliding blocks. A centering pin recess 17 is formed on the axial center line at a specified distance from the front face each sliding block. Two alignment pin recesses 27 are shown in the top surface of each sliding block in this embodiment. Likewise, a center pin recess 17 is also visible in the center of each sliding block. A sliding block center mark 128 is formed in the rim of the dowel jig drill bit recess 118 at the longitudinal center of each sliding block. The intersection of a vertical plane passing through the longitudinal center of the sliding block and a second vertical plane passing through the front face of the sliding block marks the drill bit location.

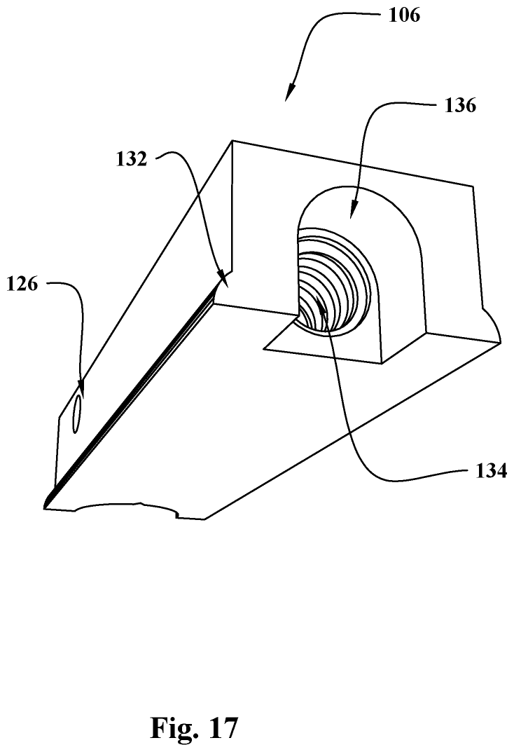

FIG. 17 shows a bottom-rear isometric view of a center sliding block 106. A locking collar recess 136 is formed in the rear of the center sliding block that allows the sliding block to pass over the locking collar (102 seen in FIG. 12). A threaded position control rod hole 134 extends through much of the center sliding block. Two center block flanges 132 and a sliding block locking rod hole 126 are also visible in this view. The base of the center sliding block is smooth.

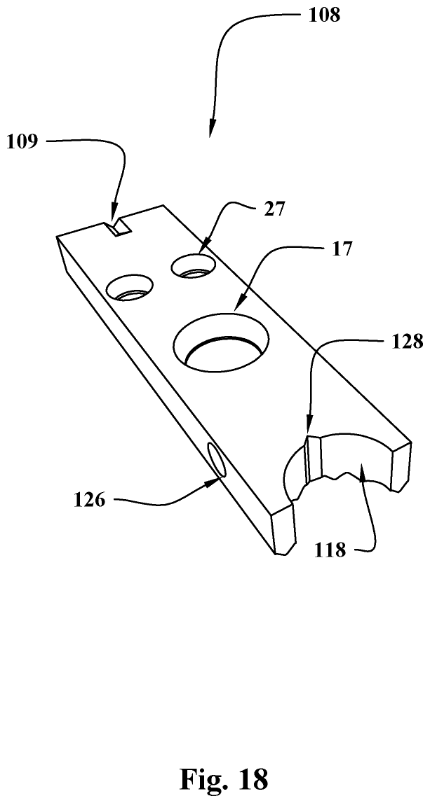

FIG. 18 shows a front-top isometric view of an outboard sliding block 108. A center pin recess 17, two alignment pin recesses 27, and a center notch 109 are formed in the top surface of the outboard sliding blocks. A locking rod hole 126 passes laterally through all sliding blocks. A dowel jig drill bit recess 118 and a center mark 128 are formed at the front end of each outboard sliding block.

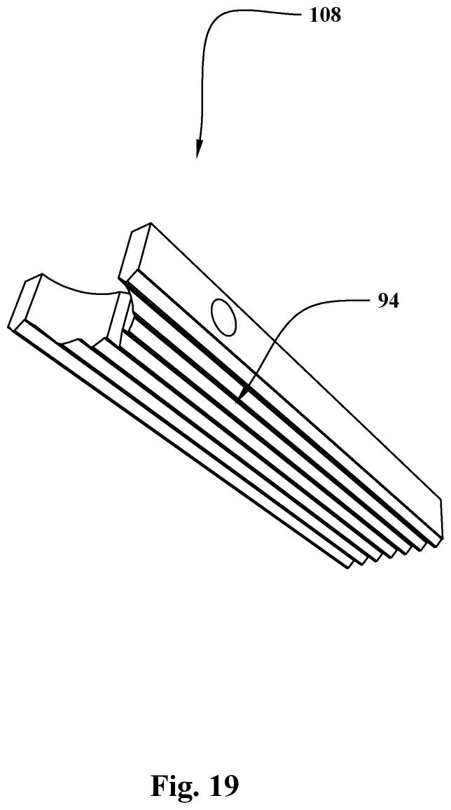

FIG. 19 shows a bottom isometric view of an outboard sliding block 108. Alignment grooves 94 are formed in the bottom surface of each outboard sliding block.

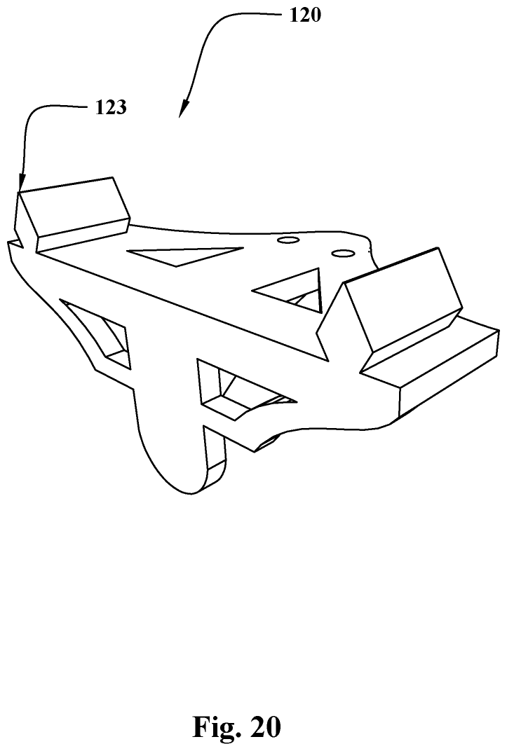

FIG. 20 shows a top-front isometric view of a dowel jig brace 120. Two dowel jig engagement fittings 123 project from the top surface of the brace. These fittings slide into dowel jig engagement slots (122 in FIG. 13). When fittings are fully inserted into engagement slots, the front face of the brace meets dowel jig alignment edges (111 in FIG. 13).

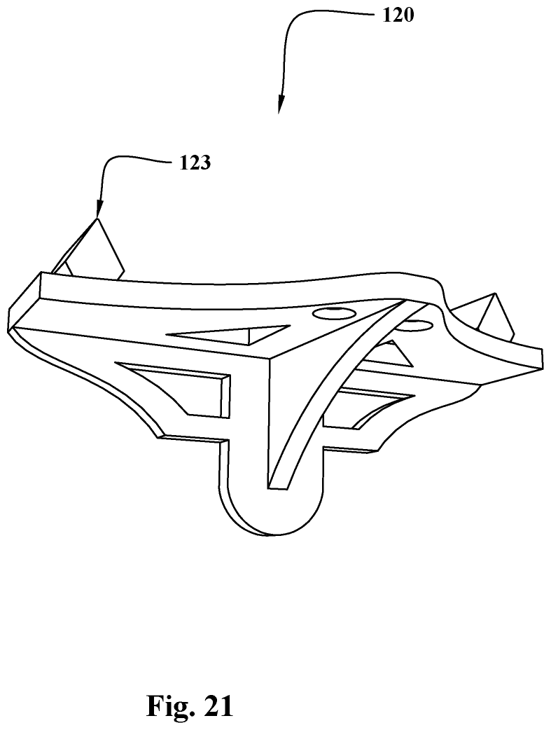

FIG. 21 shows a bottom-rear view of the dowel jig brace 120. The rear side of the dowel jig engagement fittings 123 are visible in this view. In this embodiment, the single gusset supports the two plates that form the brace. External clamps can bear upon the plate adjacent to and below the gusset plate.

### Depth Adjustment

In the stickup method, users install the bit in the drill chuck, fully insert the bit into the appropriate drill bit bushing, then position the drill guide assembly (drill guide only or drill guide and attachment) on the working surface with the drill bit point resting on that surface. Users measure the stickup length, the length of bit exposed between the top bushing and the drill chuck. Users adjust the position of the top bushing until the stickup length is equal to the hole depth. The stickup method is best employed with Multiguide and Triguide and when using an attachment.

In the stickout method, users fully insert the drill bit into the selected bushing and measure the length of bit sticking out the bottom of the drill guide. Users adjust the position of the top bushing until the stickout length is equal to the desired hole depth.

### Multiguide

The Multiguide invention disclosed in this continuation-in-part application is operated in exactly in the same way as the drill guide disclosed in the parent application when no pins are installed in the bottom face of the bottom plate. When drilling non-inclined holes into flat workpieces using drilling tools having shanks and bits of the same diameter (twist bits), no pins are installed in the base. Users install the top plate at some convenient location on the shaft and secure it in place with the double nut. Users install a drill bit of the proper size in a drill chuck, select the bushing of the proper size, then adjust the position of the top bushing using either the stickup or stickout methods of depth adjustment until the stickout length is equal to the planned hole depth. Once Multiguide is set up, users fully insert the drill bit into the selected bushing pair, rest the bit point on the working surface at a marked location, lower Multiguide to the surface, then operate the drill until the drill chuck meets the top plate while holding Multiguide firmly.

Multiguide can be set up for just one proper hole depth at a time. However, shallower pilot holes can be drilled using a second drill and a smaller and shorter bit.

Alignment pins must be installed in the base when using an attachment. A connecting bolt must be installed when using the canting base attachment. A centering pin must be installed when using the dowel jig attachment.

When using drilling tools having bits that are larger than their shanks, Multiguide must be placed on a block or the canting base attachment to provide space for the bit. Additionally, users must hold shanks against a pair of edge notches to force proper alignment. Users operate the drill until the drill chuck meets the top plate.

### Triguide

Matching bushing inserts of the right size must be installed in the appropriate threaded holes in Triguide's plate before use. Once these inserts are installed, Triguide is operated exactly like the Multiguide.

### Uniguide

Uniguide can service only one bushing size at a time. One or more segments can be added to the Uniguide body if the planned hole depth cannot be accommodated using just the Uniguide body. Users install a bottom bushing insert in the bottom of the Uniguide body. When properly installed, the bottom surface of the bottom bushing insert will be flush with the bottom surface of the Uniguide body, and the size label will be visible. Users can rotate bushing inserts using the bushing rotation tool holes using, for example, a needle-nose pliers.

Users install a top bushing insert in the top of the Uniguide body or, if one or more segments is attached to the body, the top-most segment. Users can adjust hole depth using the stickup or stickout method as they choose. After Uniguide is set for the proper depth, the locking ring is installed in the top of Uniguide and rotated until it bears on the top bushing insert fixing the bushing insert in place. CCW threads are used throughout Uniguide so that friction between bits and bushing inserts will tend to rotate inserts into contact with the bottom rim or the locking ring.

Users must adjust the height of the notch to set proper hole depth. When using drilling tools having bits that are larger than their shanks, users must first replace bushing inserts with the jack that can raise the top of edge notch to the proper level for depth control. Users hold shanks against the edge notch to force alignment.

Alignment pins and either a centering pin or connecting bolt must be installed in the Uniguide base when using it with an attachment. A connecting bolt is used to connect Uniguide to the canting base attachment, and a centering pin is used to align Uniguide with sliding blocks on the dowel jig attachment.

### Canting Base Attachment

Two alignment pins must be installed in the bottom surface of Multiguide, Triguide, and Uniguide when using them with the new canting base attachment. In the case of Multiguide and Triguide, an alignment pin must be installed in each of two threaded alignment pin holes on the opposite side of the centering pin hole from the selected bushing. The Uniguide has only two threaded alignment pin holes that can receive alignment pins, so users simply install an alignment pin in each threaded alignment pin hole. Each drill guide is placed on the canting base attachment so that both alignment pins protruding from its base fall within matching recesses in the top surface of the new canting base. Users then connect the canting base to the drill guide using a bolt that passes upward through the canting base into the threaded hole in the base of each drill guide. The assembled drill guide and canting base attachment form a unit that users can hold and guide with just one hand. Additionally, the selected bushing pair will automatically align with the new canting base.

Users can remove the canting shaft from the canting base assembly when drilling non-inclined holes into flat working surfaces. Bushings are used to align drilling tools having bits and shanks of the same diameter.

Edge notches are used to align drilling tools, such as Forstner bits, having bits that are larger than their shanks. The drill bit recess in the front face of the canting base provides space for large diameter bits. When using such tools, users hold the shank against the selected notch and lower the bit to the working surface.

The Uniguide body and segments, by themselves, cannot be adjusted to provide infinite control of depth when using the edge notch. However, infinite depth control can be provided by replacing the two bushing inserts with a threaded shaft that acts as a screw jack. Users can raise Uniguide until the proper depth is reached. Uniguide can thus be used to drill holes to precise depths that are aligned perpendicular to flat working surfaces using, for example, Forstner bits.

When drilling inclined holes into flat working surfaces, users install the canting shaft in the canting base shaft slot with canting angle graduations facing rearward. Canting angles can be set by positioning the shaft so that the selected angle graduation aligns with the top surface of the canting base. Once properly positioned, the canting shaft can be secured using the integral clamp. Users can adjust the canting angle more precisely using, for example, a bevel square. This is especially useful when the selected angle does not coincide with an angle graduation line.

Proper bit alignment for canted holes can be set by striking a line on the working surface that (1) is perpendicular to the plane through which the hole should pass and (2) passes through the marked hole location. Users place the canting base assembly on the working surface so that the drill bit point falls on the marked hole location and the pivot edge of the canting base aligns with the struck line.

When drilling non-inclined holes in cylinders, users can remove canting shafts from the canting base. Users place the canting base assembly (canting base and drill guide) on cylinders so that the groove in its base conforms to the cylinder, then adjust the drill guide for hole depth using the stickup method. They place the assembly on the cylinder so that the drill bit point meets the marked hole location and advance the drill bit until the drill chuck meets the top bushing.

When drilling inclined holes in cylinders, angle graduations on the canting shaft cannot be used. The canting shaft must be installed in the canting base attachment with the angle graduations facing left or right rather than rearward. The canting base assembly (canting base and drill guide) should be placed on the cylinder so that the deep groove in the canting base conforms to the cylinder. Users must adjust the canting shaft until the top surface of the canting base is canted at the proper angle as measured externally. For example, a user can set a bevel square to the proper angle, then adjust the position of the canting shaft until the top surface of the canting base meets the blade of the bevel square when the bevel square is held against both the cylinder and canting base.

### Dowel Jig Attachment

Users can drill multiple equally spaced-apart and accurately aligned dowel holes to precise depths into the edges and faces of planar workpieces using a new drill guide and new dowel jig attachment disclosed in this continuation-in-part application. Dowel holes will be aligned at constant distances from edges, evenly spaced apart by gauged distances, aligned perpendicular to work surfaces, and extended to precise depths.

In these embodiments disclosed in this continuation-in-part application, the dowel jig and alignment system combine to allow users to drill up to five evenly spaced and properly aligned dowel holes at one jig setup location in edges or faces of planar work surfaces. The jig's center and outboard sliding blocks move in unison. The center block slides within a wide, flat-bottomed central groove in the dowel jig. Central sliding block flange grooves are formed in the dowel jig at the bottom of the center sliding block groove. Flanges on the center sliding block engage these flange grooves and prevent vertical movement. Vertical movement of all outboard sliding blocks is also prevented because the locking rod passes through all sliding blocks including the center sliding block.

Outboard sliding blocks have grooved bottom surfaces and slide on grooved top surfaces of dowel jig bodies. Outboard sliding blocks can be shifted left or right incrementally relative to center sliding blocks providing numerous gauged spacing distances between dowel holes. This new dowel jig invention supports standard dowel spacing intervals. It has spacing alignment notches on the back wall of the dowel jig body, center notches on the outboard sliding blocks, and compatible groove widths in the top surfaces of the dowel jig body. For example, one European standard spacing is 32 mm, and one US standard spacing is 1¼ inch. This new dowel jig invention can support either of these standard spacings, but not simultaneously, and numerous non-standard spacings.

Front faces of center and outboard sliding blocks are in the same plane as the drill bit and allow users to accurately position dowel holes at marked locations. This invention provides infinite control over position relative to the thickness of an edge, and numerous gauged lateral spacing distances.

Users drilling dowel holes into an edge of a workpiece can complete these steps:
Mark a line on the edge through which dowel holes are to be drilled (typically, a center line)
Adjust sliding blocks for the desired hole spacing intervals
Mark the location of the dowel hole to be drilled using the center sliding block with a point, circle, and a line passing through the point that is perpendicular to the marked line
Position the dowel jig on the workpiece so that the center sliding block is aligned with the marked hole location
Clamp the dowel jig to the workpiece
Adjust the position of the sliding blocks so that their front faces align with the line marked on the workpiece
Adjust the position of the sliding blocks so that their front faces align with the line marked on the workpiece.
Mark a line on the workpiece edge along one side of the center sliding block
Adjust the drill guide for proper depth
Place the drill guide on a sliding block and drill the hole until the drill chuck meets the drill guide
Repeat for each sliding block

The procedure listed above will have many variations in practice but demonstrates one feasible and practical procedure for drilling dowel holes in an edge of a workpiece.

This new dowel jig has no need of sliding adapters; thus, users do not need to maintain a rearward acting force on Multiguide, Triguide, or Uniguide while drilling dowel holes. This change reduces the risk that a dowel hole will be drilled in the wrong location and increases safety since the system is more stable. Additionally, the new dowel jig is thinner and has a lower parts count compared to the original dowel jig. Thus, the new dowel jig represents a betterment over the original dowel jig disclosed in the parent application.

### OTHER EMBODIMENTS

No new embodiments beyond those disclosed in this continuation-in-part application are known. However, it is possible to eliminate one alignment pin from the new embodiments. In that case, the single alignment pin would be placed in alignment with the corresponding bushing. Two alignment pins were used in the drill guide disclosed in the parent application to reduce Multiguide plate diameter. Additionally, if a user loses one alignment pin, the second alignment pin will suffice. If only one alignment pin hole is provided, and the user loses the single alignment pin, then the tools cannot be aligned with attachments. Thus, providing two alignment pins provides some redundancy.

### Method of Manufacture

Multiguide can be composed of hardened steel that can form effective drill bit bushings. Triguide and Uniguide can be composed of metal but will probably be composed largely of plastic. Hard steel bushings can be carried in plastic inserts, or the entire insert can be composed of steel. Threaded rods and nuts will be composed of steel. Other miscellaneous parts will be composed of plastic and produced using injection molding techniques. Some limited post-injection processing may be required for attachments. Both attachments can employ cylindrical metal inserts having external and internal threads that engage threaded metal rods. These inserts are installed in threaded holes in attachments. Both the canting base and dowel jig attachments can be produced using injection molding techniques.

What is claimed is:

1. A drill guide (Multiguide) comprised of:
a bottom circular plate with integral threaded shaft,
a top circular plate with integral threaded collar, and
a locking double nut that together align drill bits and limit depth of drilling.

2. A system according to claim 1, said shaft having threads interrupted by three longitudinal alignment grooves.

3. A system according to claim 1, said bottom and top plates having:
a multiplicity of matching and aligned smooth holes, and
a multiplicity of semi-circular edge notches of various sizes arranged symmetrically about the plate center in a favorable order that serve as drill bit bushings.

4. A system according to claim 1, said threaded collar having a central hole conforming to the shaft cross-sectional shape that aligns top and bottom plates and their bushings.

5. A system according to claim 1, said double nut having:
an upper internally threaded section conforming to shaft threads, and
a lower internally threaded section conforming to collar threads that secures top plates to shafts when fully engaged with collars.

6. A centering, aligning, and connecting system comprised of:
a threaded center hole in each drill guide that can receive either a centering pin or connecting bolt, and
one or two threaded alignment pin holes per bushing in the bottom surface of each drill guide that can receive pins that engage conforming recesses in attachments centering, aligning and connecting drill guides to attachments.

7. A system (Triguide) comprised of:
a bottom triangular plate with integral threaded shaft,
top triangular plate with integral threaded collar, and
a locking double nut that together align drill bits and limit depth of drilling.

8. A system according to claim 7, said shaft, collar, and double nut being similar in shape and function to that on the Multiguide from claim 1.

9. A system according to claim 7, top surface of said top plate and bottom surface of said bottom plate each having notched corners and three large diameter partially penetrating counter-clockwise (CCW) threaded holes that can receive CCW threaded inserts that include a bushing at their center.

10. A drill guide (Unibody) comprised of:
a roughly cylindrical body,
top and bottom bushing inserts,
a bushing locking ring,
a short, roughly planar lateral extension (hand hold), and
a tall lateral extension that includes a V-notch and stop block.

11. A system according to claim 10, said bushings align twist drill bits and limit hole depth, and said V-notch aligns drilling tools having bits that are larger than their shanks.

12. A system according to claim 10, said Uniguide body having:
a large diameter, shallow, CCW threaded hole at its base that can receive a large diameter bushing insert,
a slightly smaller CCW threaded hole throughout the upper portion of the body that can receive a slightly smaller bushing insert, and
a short section of external threads at its top.

13. A system according to claim 10, said bushing inserts having external CCW threads and a center hole than can receive a bushing.

14. A system according to claim 10, said locking ring prevents clockwise bushing rotation due to friction between rotating drill bits and bushings.

15. A system according to claim 10, said hand hold having a shallow threaded hole that can receive a threaded centering pin or threaded connecting bolt, and one or more separate threaded alignment pin holes that can receive replaceable alignment pins.

16. A system according to claim 10, said body having an opening (window) on one side that permits the removal of cuttings from between the two bushing inserts.

17. A system according to claim 10, said Uniguide having an attachment (jack) that raises Uniguide above working surfaces allowing for precise drilling depth control when using drilling tools having shanks that are smaller than their bits.

18. A system according to claim 17, said jack having a cylindrical body and external CCW threads that mesh with threads in the upper portion of Uniguide.

19. A system according to claim 10, said Uniguide having an attachment (segment) that allows Uniguide to work with long bits; segments being identical to the Uniguide body but lacking the hand hold and window, but also having a projection that conforms to the stop block.

20. A canting base attachment to all drill guides that allows the drilling of holes at inclined angles on both flat surfaces and through cylinder centers that is comprised of:
a thick, roughly cylindrical body having a deep V-shaped groove in its base,
a canting shaft fixture on its back end, and
a squared-off front end with a large drill bit recess at its center.

21. A system according to claim 20, said deep groove centering the canting base and drill guide on cylinders.

22. A system according to claim 20, said fixture housing a shaft having angle graduations that cants the base and drilling tools when lowered and secured in place by an integral clamp.

23. A system according to claim 20, said drill bit recess providing space for large bits.

24. A system according to claim 20, said squared-off front end providing a means to accurately align drill bits on working surfaces.

25. A system according to claim 20, said canting base attachment having:
smooth recesses in its top surface that can receive alignment pins used to align drill guides with the canting base, and
a smooth center hole that can receive a bolt that connects drill guides to the canting base forming a unit that can be manipulated and controlled using just one hand.

26. A dowel jig attachment to drill guides comprised of:
a roughly rectangular body having raised side and back walls,
a center sliding block,
a multiplicity of outboard sliding blocks,
a smooth sliding block locking rod,
threaded position control rod with knob, and
two clamps with knob and threaded rod.

27. A system according to claim 26, said body having two top uniformly grooved rectangular surfaces separated by a flat-bottomed center groove.

28. A system according to claim 26, said flat-bottomed center groove having longitudinal flange recesses extending laterally from the bottom of the groove into the jig body that prevent vertical movement of the central sliding block.

29. A system according to claim 26, said body having a front alignment edge that conforms the jig to workpiece edges.

30. A system according to claim 26, said body having one or more brace engagement slots at the bottom-front of the jig that secure a brace to the dowel jig body.

31. A system according to claim 26, said dowel jig body having a groove at the center of the front face used in aligning the jig with workpieces.

32. A system according to claim 26, said center sliding block having:
a roughly rectangular plan shape,
a flat bottom with flanges on the lower longitudinal edges,
a drill bit recess at its front end,
a longitudinal threaded hole extending from the back end nearly to the front end that receives a threaded position control rod,
a transverse hole located near the block front, and
recesses for a center pin and one or two alignment pins in its top surface.

33. A system according to claim 26, said outboard sliding blocks having:
a roughly rectangular plan shape,
a grooved bottom surface that conforms to dowel jig top surface grooves,
a drill bit recess at the front end,
transverse hole located near the block front, and
recesses for a center pin and one or two alignment pins in its top surface.

34. A system according to claim 26, said threaded position control rod serving to move the sliding blocks fore and aft relative to the dowel jig body.

35. A system according to claim 26, said clamps secure the jig to workpieces.
